(19) United States
(12) Patent Application Publication
(10) Pub. No.: US 2006/0089882 A1
(43) Pub. Date: Apr. 27, 2006

(54) On-line shopping system

(76) Inventor: Yair Shimansky, Cape Town (ZA)

Correspondence Address: NIXON PEABODY, LLP, 401 9TH STREET, NW, SUITE 900, WASHINGTON, DC, 20004-2128, US

(21) Appl. No.: 10/515,425

(22) PCT Filed: May 28, 2002
(86) PCT No.: PCT/IB02/01843

§ 371 Date: Dec. 9, 2005

(51) Int. Cl. G06Q 30/00

(52) U.S. Cl. 705/26

(57) ABSTRACT

An on-line shopping system for selling a product over an electronic communication network such as the Internet (as detailed in FIG. 1). The shopping system comprises an e-commerce supplier processor, which is accessible by a number of potential buyers of the product, via the Internet. The processor has software executable thereon which is configured to receive binding on-line purchase offers from buyers of the product. The buyers will be required to register on-line as part of a buying group. The software is operable to complete the sales transactions at a future end price that is the same as or lower than the starting price and that is determined by the number of buyers in the buying group, when either of an expiry date of the supplier's offer or a minimum sales price is achieved.

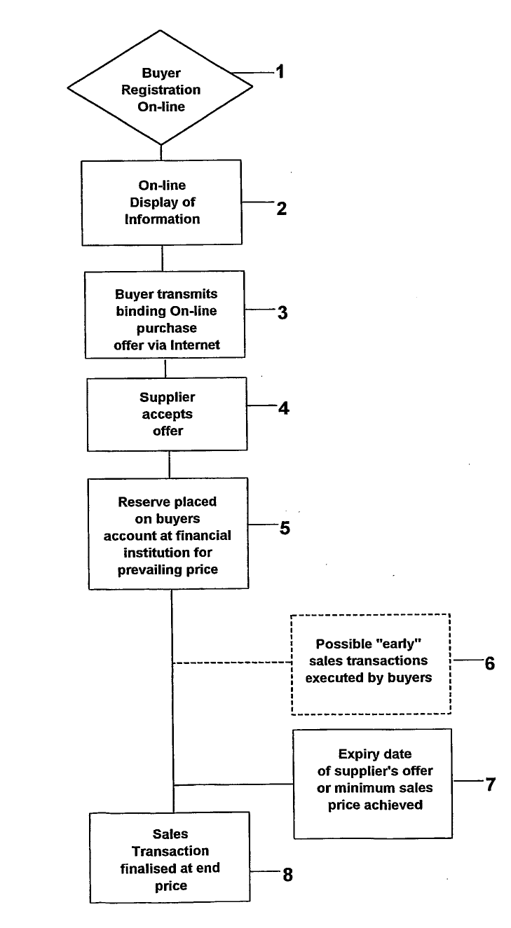

### FIELD OF INVENTION

THIS INVENTION relates to an on-line shopping system.

It also relates to a method of shopping on-line.

It relates particularly to the sale of goods or services (hereinafter referred to as “products”) over communication networks such as the Internet and cellular telecommunication networks.

### SUMMARY OF INVENTION

According to first aspect of the invention there is provided

an on-line shopping system for selling a product over a communication network, the shopping system comprising e-commerce supplier processing means having software executable on the supplier processing means, that is operable to record a starting price for the product and to receive binding on-line purchase offers for the product, from buyers forming part of a buying group of the product, the software being configured to complete the sale transactions at a future end price that is the same as or lower than the starting price and that is determined by the number of purchase offers received from buyers in the buying group, when one of a predetermined period of time has expired and a minimum sales price for the product is achieved.

The software may be configured to accept inputs from buyers for registering the buyers with the supplier of the product, as part of an on-line buying group for purchasing the product.

The software may be configured to calculate a prevailing sales price as a function of the number of purchase offers received from buyers in the buying group, the software being configured to re-calculate the prevailing sales prices in response to more purchase offers being received from buyers in the buying group.

The software may be configured to generate data that can be transmitted to registered buyers via the communication network, the data including at least one of the quantity of the product that is available for sale to registered buyers the sales of the product price prevailing from time to time, the number of purchase offers required to drive the sales price of the products down to various specified price levels, the starting price, a minimum selling price for the product, a starting date of the supplier's offer to the buying group and an expiry date of the supplier's offer.

The on-line shopping system may be operable to communicate with a financial institution at which a buyer forming part of the buying group, holds an account, to place a reserve on sufficient funds in the account to cover the prevailing sales price.

The software may be configured to effect credit card sales transactions with buyers in a buying group, the software being configured to receive data from buyers, containing sufficient information to execute credit card sales transactions with the buyers.

According to a second aspect of the invention there is provided an on-line shopping program product which when run on a computer device which is connected to a communication network, is operable to sell a product over the communication network, the program product being operable to:
record a starting price for the product;
receive binding on-line purchase offers for the product from buyers forming part of a buying group of the product; and
execute sales transactions between the supplier and the buyers at a future end price that is the same as or lower than the starting price and that is determined by the number of purchase offers received from buyers in the buying group, when one of a predetermined period of time has expired and a minimum sales price for the product is achieved.

The on-line shopping program product may be configured to accept inputs from buyers for registering the buyers with the supplier of the product, as part of an on-line buying group for purchasing the product.

The on-line shopping program product may be configured to calculate prevailing sales prices as a function of the number of purchase offers received from buyers in the buying group, the software being configured to re-calculate the prevailing sales price in response to more purchase offers being received from buyers in the buying group making binding on-line purchase offers.

The on-line shopping program product may be configured to generate data that can be transmitted to registered buyers via the communication network, the data including at least one of the quantity of the product that is available for sale to registered buyers, the sales price of the product prevailing from time to time, the number of purchase offers required to drive the sales price of the product down to various specified levels, the starting price, a minimum selling price for the product, a starting date of the supplier's offer to the buying group and an expiry date of the supplier's offer.

The on-line shopping program product may be operable to communicate with a financial institution at which a buyer forming part of the buying group, holds an account, to place a reserve on sufficient funds in the account to cover the prevailing sales price.

The on-line shopping program product may be configured to effect credit card sales transactions with buyers in a buying group, the program product being configured to receive data from buyers, containing sufficient information to execute credit card sales transactions with the buyers.

According to a third aspect of the invention there is provided a method of selling a product on-line over a communication network which includes:
recording a starting price for the product;
receiving binding on-line purchase offers for the product from buyers forming part of a buying group of the product; and
executing sales transactions between the supplier and the buyers at a future price that is the same as or lower than the starting price and that is determined by the number of purchase offers received from buyers in the buying group, when one of a predetermined period of time has expired and a minimum sales price for the product is achieved.

### BRIEF DESCRIPTION OF THE DRAWINGS

Further features of the invention are described hereinafter by way of a non-limiting example of the invention with reference to and as illustrated in the accompanying drawing of a flow chart.

### DESCRIPTION OF THE PREFERRED EMBODIMENTS

The on-line shopping system comprises an e-commerce supplier processor that has software executable thereon. The processor is accessible by a number of potential buyers via the Internet. The software is configured to receive binding on-line purchase offers from buyers for a particular product, for example, cases of red wine. It will be appreciated that in other embodiments of the invention, the shopping system may be operable to receive binding purchase offers via a wireless telecommunication network such as a cellular telecommunication network.

As a first step, potential buyers of one or more cases of red wine will be required to register on-line as part of a buying group for purchasing one or more cases of the red wine (see block 1 of the flow chart). As such, the software is configured to accept inputs containing the personal particulars of potential buyers for registering the buyers on-line as part of the buying group. The personal particulars required for registration include the name, postal address (and a delivery address if different to the postal address), e-mail address, contact telephone numbers and the details of an account at a financial institution which can be debited to pay for wine purchases made by the buyer.

The software is configured to display data (see block 2) which is accessible by registered buyers via the Internet. The data includes a) the quantity of cases of red wine that are available for sale to registered buyers, b) the starting date of the supplier's offer to buyers (for example 1 Jul. 2000), c) the expiry date of the supplier's offer (for example 15 Jul. 2000), d) the starting price (for example US $90) per case, e) the minimum sales price (for example US $50) per case, f) information on the number of buyers required to drive the sales price of the cases of wine down to various specified price levels, g) the quantity of cases for which binding purchase offers have been received from buyers in the buying group from time to time, and h) the sales prices prevailing from time to time.

In order to purchase one or more cases of red wine, each buyer will be required to transmit a binding on-line purchase offer for a specified number of cases at the prevailing sales price which will be equal to or less than the starting sales price of US $90 (see block 3). The buyer's offer is accepted by the supplier (see block 4) and the software is configured to communicate with the buyer's financial institution to place a reserve for the amount of the prevailing sales price on the buyer's account held at the financial institution. In an example wherein the buyer holds a credit card account at a bank, the software is configured to communicate with the buyer's bank to execute a credit card sales transaction wherein a “block” is placed on the buyer's credit card account for the amount of the purchase price of the cases of red wine which the buyer wishes to purchase at the sales price per case prevailing at the time the offer is made by the buyer.

At the expiry date of the supplier's offer or if the minimum sales price of US $50 for a case of wine is achieved before then (see block 7), the software of the supplier processor is configured to complete the sales transaction between the supplier and all of the buyers in the buying group at the prevailing sales price per case at the time (see block 8). Clearly the sales price per case of red wine at the date when the sales transaction between the buyer and the supplier is finalised, will not be known and will be determined by the number of cases purchased by all of the buyers in the buying group. The shopping system thus allows all the buyers wishing to buy cases of red wine to join forces in a buying group that is formed specifically to gain bulk buying power for the purpose of driving the price of the product down.

The software is configured to allow buyers to communicate instructions to the supplier processing means for completing the sales transaction between the supplier and a particular buyer at a prevailing sales price prior to the expiry date of the supplier's offer or the minimum sales price being achieved (see block 6). As such, the software is configured to receive instructions from buyers to execute such “early” sales transactions. Such “early” sales transaction is executed without affecting the order volume achieved.

The software may be operable to generate a unique code for each buyer in the buying group in order to facilitate a reward system for buyers who refer the supplier's product offering to other buyers. The software may be configured to receive the unique code from such other buyers when they make an on-line purchase offer and to record the unique code, to enable the buyer responsible for the referral to be rewarded. In this way, a buyer becomes, in effect, a representative of the supplier.

It will be appreciated that the shopping system, while being advantageous to buyers, is also advantageous to suppliers. The supplier of the cases of red wine, for example, will be able to monitor the demand for the red wine and react accordingly. Thus, a bulk order for the red wine will be created which can then be transported to a distributor for delivery to the buyers. This will result in labour, freight and administration cost savings to the supplier as the purchase of the cases of red wine by the buyers in the buying group can generally be dealt with by the supplier as a bulk sale. Furthermore, the shopping system will also assist suppliers in maintaining appropriate stock levels of their product. It will thus not be necessary for a supplier to maintain high stock levels to meet possible larger than normal purchase orders which may never materialise and will also assist in providing suppliers with advance warning of large orders.

From a marketing perspective, the Applicant believes that the on-line shopping system has a number of advantages, including the fact that there is clearly an incentive for buyers to co-opt other buyers onto the system in order to further drive the price of the product down.

1. An on-line shopping system for selling a product over a communication network, the shopping system comprising e-commerce supplier processing means having software executable on the supplier processing means, that is operable to record a starting price for the product and to receive binding on-line purchase offers for the product, from buyers forming part of a buying group of the product, the software being configured to complete the sale transactions at a future end price that is the same as or lower than the starting price and that is determined by the number of purchase offers received from buyers in the buying group, when one of a predetermined period of time has expired and a minimum sales price for the product is achieved.

2. An on-line shopping system as claimed in claim 1, wherein the software is configured to accept inputs from buyers for registering the buyers with the supplier of the product, as part of an on-line buying group for purchasing the product.

3. An on-line shopping system as claimed in claim 1, wherein the software is configured to calculate a prevailing sales price as a function of the number of purchase offers received from buyers in the buying group, the software being configured to re-calculate the prevailing sales prices in response to more purchase offers being received from buyers in the buying group.

4. An on-line shopping system as claimed in claim 3, wherein the software is configured to generate data that can be transmitted to registered buyers via the communication network, the data including at least one of the quantity of the product that is available for sale to registered buyers, the sales price of the product prevailing from time to time, the number of purchase offers required to drive the sales price of the products down to various specified price levels, the starting price, a minimum selling price for the product, a starting date of the supplier's offer to the buying group, the quantity of the product for which binding purchase offers have been received and an expiry date of the supplier's offer.

5. An on-line shopping system as claimed in claim 1, which is operable to communicate with a financial institution at which a buyer forming part of the buying group, holds an account, to place a reserve on sufficient funds in the account to cover the prevailing sales price.

6. An on-line shopping system as claimed in claim 5, wherein the software is configured to effect credit card sales transactions with buyers in a buying group, the software being configured to receive data from buyers, containing sufficient information to execute credit card sales transactions with the buyers.

7. An on-line shopping program product which when run on a computer device which is connected to a communication network, is operable to sell a product over the communication network, the program product being operable to:
record a starting price for the product;
receive binding on-line purchase offers for the product from buyers forming part of a buying group of the product; and
execute sales transactions between the supplier and the buyers at a future end price that is the same as or lower than the starting price and that is determined by the number of purchase offers received from buyers in the buying group, when one of a predetermined period of time has expired and a minimum sales price for the product is achieved.

8. An on-line shopping program product as claimed in claim 7, which is configured to accept inputs from buyers for registering the buyers with the supplier of the product, as part of an on-line buying group for purchasing the product.

9. An on-line shopping program product as claimed in claim 7, which is configured to calculate prevailing sales prices as a function of the number of purchase offers received from buyers in the buying group, the software being configured to re-calculate the prevailing sales price in response to more purchase offers being received from buyers in the buying group making binding on-line purchase offers.

10. An on-line shopping program product as claimed in claim 9, which is configured to generate data that can be transmitted to registered buyers via the communication network, the data including at least one of the quantity of the product that is available for sale to registered buyers, the sales price of the product prevailing from time to time, the number of purchase offers required to drive the sales price of the product down to various specified levels, the starting price, a minimum selling price for the product, a starting date of the supplier's offer to the buying group, the quantity of the product for which binding purchase offers have been received and an expiry date of the supplier's offer.

11. An on-line shopping program product as claimed in claim 7, which is operable to communicate with a financial institution at which a buyer forming part of the buying group, holds an account, to place a reserve on sufficient funds in the account to cover the prevailing sales price.

12. An on-line shopping program product as claimed in claim 11, which is configured to effect credit card sales transactions with buyers in a buying group, the program product being configured to receive data from buyers, containing sufficient information to execute credit card sales transactions with the buyers.

13. A method of selling a product on-line over a communication network which includes:
recording a starting price for the product;
receiving binding on-line purchase offers for the product from buyers forming part of a buying group of the product; and
executing sales transactions between the supplier and the buyers at a future price that is the same as or lower than the starting price and that is determined by the number of purchase offers received from buyers in the buying group, when one of a predetermined period of time has expired and a minimum sales price for the product is achieved.

14. (canceled)

15. (canceled)

16. (canceled)

17. (canceled)

18. (canceled)

19. (canceled)
